(19) United States
(12) Patent Application Publication
(10) Pub. No.: US 2012/0300024 A1
(43) Pub. Date: Nov. 29, 2012

(54) IMAGING SYSTEM

(75) Inventor: Scott McEldowney, Redmond, WA (US)

(73) Assignee: MICROSOFT CORPORATION, Redmond, WA (US)

(21) Appl. No.: 13/115,694

(22) Filed: May 25, 2011

(51) Int. Cl. H04N 13/00

(52) U.S. Cl. 348/42; 348/E13.001

(57) ABSTRACT

A three-dimensional imaging system to reduce detected ambient light comprises a wavelength stabilized laser diode to project imaging light onto a scene, an optical bandpass filter, and a camera to receive imaging light reflected from the scene and through the optical bandpass filter, the camera configured to use the received imaging light for generating a depth map of the scene.

### BACKGROUND

Three-dimensional imaging systems utilize depth cameras to capture depth information of a scene. The depth information can be translated to depth maps in order to three-dimensionally map objects within the scene. Some depth cameras use projected infrared light to determine depth of objects in the imaged scene. Accurate determination of the depth of objects in the scene can be hindered when excess ambient light in the scene disrupts the camera's ability to receive the projected infrared light.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A 3-D imaging system for blocking ambient light is disclosed. The system includes a wavelength stabilized laser diode to project imaging light onto a scene, a temperature controller to control a temperature of the laser diode throughout a range of ambient temperatures, an optical bandpass filter having a very narrow transmission range, and a camera to receive imaging light reflected from the scene and through the optical bandpass filter.

### BRIEF DESCRIPTION OF THE DRAWINGS

FIG. 1 shows a three-dimensional imaging system viewing an observed scene in accordance with an embodiment of the present disclosure.

FIG. 2 somewhat schematically shows the modeling of a human target with a virtual skeleton.

FIGS. 3-4 show various embodiments of a capture device according to the present disclosure.

FIG. 5 schematically shows a nonlimiting computing system.

FIG. 6 shows a wavelength stabilized laser diode in accordance with an embodiment of the present disclosure.

FIG. 7 shows another wavelength stabilized laser diode in accordance with an embodiment of the present disclosure.

### DETAILED DESCRIPTION

A three-dimensional imaging system, such as a 3D-vision gaming system, may include a depth camera capable of observing objects within a scene. As one example, a depth camera can observe game players as they play a game. As the depth camera captures images of a player within an observed scene (i.e., the imaged scene in the field of view of the depth camera), those images may be interpreted and modeled with one or more virtual skeletons. As described in more detail below, excess ambient light may cause problems with the depth images captured by the depth camera leading to areas of invalid depth information in the depth images. This can disrupt imaging and subsequent modeling of the player.

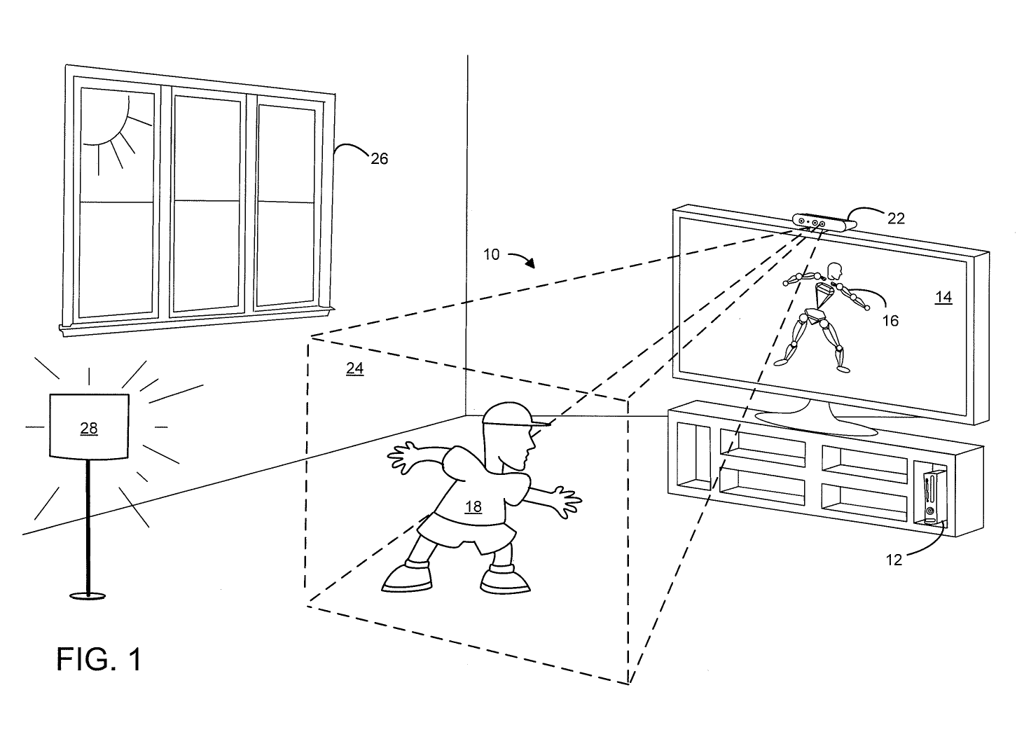

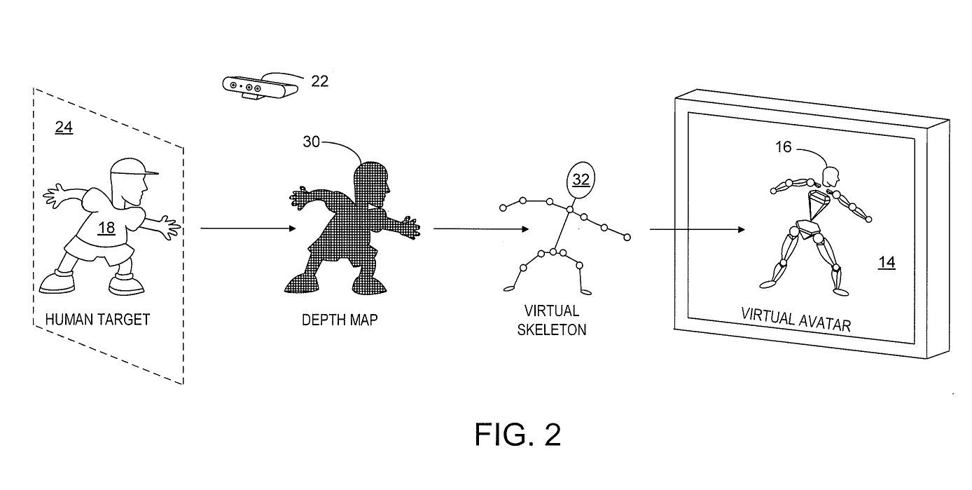

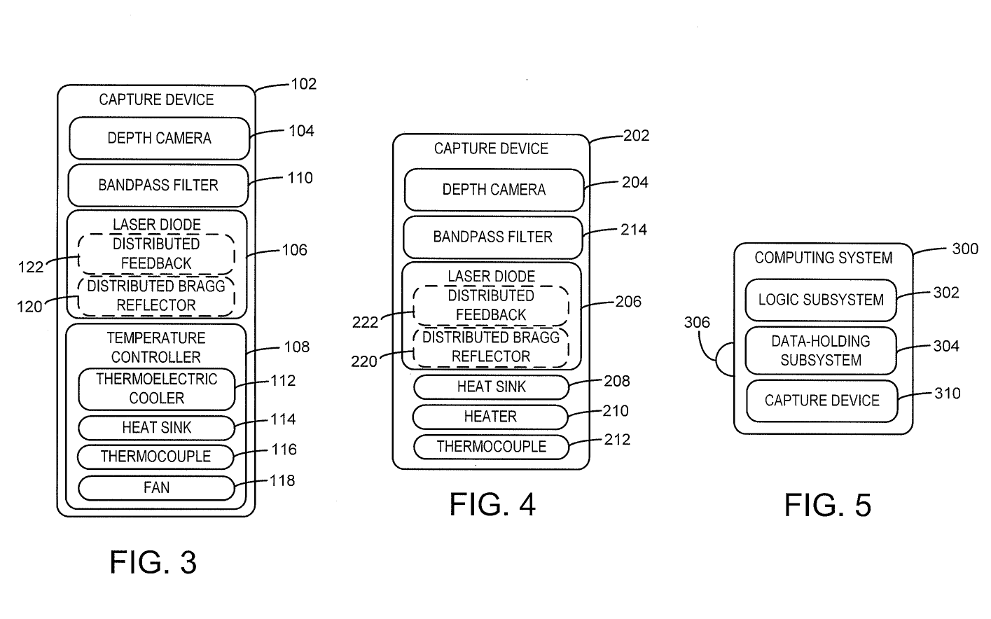

FIG. 1 shows a nonlimiting example of a three-dimensional imaging system 10. In particular, FIG. 1 shows a gaming system 12 that may be used to play a variety of different games, play one or more different media types, and/or control or manipulate non-game applications and/or operating systems. FIG. 1 also shows a display device 14 such as a television or a computer monitor, which may be used to present game visuals to game players. As one example, display device 14 may be used to visually present a virtual avatar 16 that human target 18 controls with his movements. The 3-D imaging system 10 may include a capture device, such as a depth camera 22, that visually monitors or tracks human target 18 within an observed scene 24. Depth camera 22 is discussed in greater detail with respect to FIGS. 2 and 3.

Human target 18 is shown here as a game player within observed scene 24. Human target 18 is tracked by depth camera 22 so that the movements of human target 18 may be interpreted by gaming system 12 as controls that can be used to affect the game being executed by gaming system 12. In other words, human target 18 may use his or her movements to control the game. The movements of human target 18 may be interpreted as virtually any type of game control. Some movements of human target 18 may be interpreted as controls that serve purposes other than controlling virtual avatar 16. Movements may also be interpreted as auxiliary game management controls. For example, human target 18 may use movements to end, pause, save, select a level, view high scores, communicate with other players, etc.

Depth camera 22 may also be used to interpret target movements as operating system and/or application controls that are outside the realm of gaming. Virtually any controllable aspect of an operating system and/or application may be controlled by movements of a human target 18. The illustrated scenario in FIG. 1 is provided as an example, but is not meant to be limiting in any way. To the contrary, the illustrated scenario is intended to demonstrate a general concept, which may be applied to a variety of different applications without departing from the scope of this disclosure.

The methods and processes described herein may be tied to a variety of different types of computing systems. FIG. 1 shows a nonlimiting example in the form of gaming system 12, display device 14, and depth camera 22. In general, a 3-D imaging system may include a computing system 300, shown in simplified form in FIG. 5, which will be discussed in greater detail below.

FIG. 2 shows a simplified processing pipeline in which human target 18 in an observed scene 24 is modeled as a virtual skeleton 32 that can be used to draw a virtual avatar 16 on display device 14 and/or serve as a control input for controlling other aspects of a game, application, and/or operating system. It will be appreciated that a processing pipeline may include additional steps and/or alternative steps than those depicted in FIG. 2 without departing from the scope of this disclosure.

As shown in FIG. 2, human target 18 and the rest of observed scene 24 may be imaged by a capture device such as depth camera 22. The depth camera may determine, for each pixel, the depth of a surface in the observed scene relative to the depth camera. Virtually any depth finding technology may be used without departing from the scope of this disclosure. For example, structured light or time-of-flight depth finding technologies may be used. Example depth hardware is discussed in more detail with reference to capture device 310 of FIG. 5.

The depth information determined for each pixel may be used to generate a depth map 30. Such a depth map may take the form of virtually any suitable data structure, including but not limited to a matrix that includes a depth value for each pixel of the observed scene. In FIG. 2, depth map 30 is schematically illustrated as a pixelated grid of the silhouette of human target 18. This illustration is for simplicity of understanding, not technical accuracy. It is to be understood that a depth map generally includes depth information for all pixels, not just pixels that image the human target 18, and that the perspective of depth camera 22 would not result in the silhouette depicted in FIG. 2.

Virtual skeleton 32 may be derived from depth map 30 to provide a machine readable representation of human target 18. In other words, virtual skeleton 32 is derived from depth map 30 to model human target 18. The virtual skeleton 32 may be derived from the depth map in any suitable manner. In some embodiments, one or more skeletal fitting algorithms may be applied to the depth map. The present disclosure is compatible with virtually any skeletal modeling techniques.

The virtual skeleton 32 may include a plurality of joints, each joint corresponding to a portion of the human target. In FIG. 2, virtual skeleton 32 is illustrated as a fifteen-joint stick figure. This illustration is for simplicity of understanding, not technical accuracy. Virtual skeletons in accordance with the present disclosure may include virtually any number of joints, each of which can be associated with virtually any number of parameters (e.g., three dimensional joint position, joint rotation, body posture of corresponding body part (e.g., hand open, hand closed, etc.) etc.). It is to be understood that a virtual skeleton may take the form of a data structure including one or more parameters for each of a plurality of skeletal joints (e.g., a joint matrix including an x position, a y position, a z position, and a rotation for each joint). In some embodiments, other types of virtual skeletons may be used (e.g., a wireframe, a set of shape primitives, etc.).

As shown in FIG. 2, a virtual avatar 16 may be rendered on display device 14 as a visual representation of virtual skeleton 32. Because virtual skeleton 32 models human target 18, and the rendering of the virtual avatar 16 is based on the virtual skeleton 32, the virtual avatar 16 serves as a viewable digital representation of the human target 18. As such, movement of virtual avatar 16 on display device 14 reflects the movements of human target 18.

In some embodiments, only portions of a virtual avatar will be presented on display device 14. As one nonlimiting example, display device 14 may present a first person perspective to human target 18 and may therefore present the portions of the virtual avatar that could be viewed through the virtual eyes of the virtual avatar (e.g., outstretched hands holding a steering wheel, outstretched arms holding a rifle, outstretched hands grabbing a virtual object in a three-dimensional virtual world, etc.).

While virtual avatar 16 is used as an example aspect of a game that may be controlled by the movements of a human target via the skeletal modeling of a depth map, this is not intended to be limiting. A human target may be modeled with a virtual skeleton, and the virtual skeleton can be used to control aspects of a game or other application other than a virtual avatar. For example, the movement of a human target can control a game or other application even if a virtual avatar is not rendered to the display device.

Returning to FIG. 1, an example embodiment is shown depicting one or more sources of ambient light that can result in invalid depth information in the depth image. Window 26 is allowing sunlight to enter the observed scene 24. In addition, lamp 28 is on. Excess light in the imaged scene can overwhelm the projected infrared light that the depth camera uses to determine depth of surfaces in the scene, reducing the distance at which the depth camera can accurately model the virtual skeleton.

Embodiments of a 3-D imaging system to reduce the amount of ambient light received at a capture device will now be described with respect to FIGS. 3 and 4. Turning to FIG. 3, an actively cooled capture device 102 designed to block a very large spectrum of ambient light is shown. Capture device 102 includes a depth camera 104 configured to use imaging light to generate a depth map (e.g., depth map 30 of FIG. 2). The depth camera 104 may use any suitable method to analyze the received imaging light, such as time of flight analysis or structured light analysis.

The depth camera 104 may itself be configured to generate a depth map from the received imaging light. The depth camera 104 may thus include an integrated computing system (e.g., computing system 300 shown of FIG. 5). The depth camera 104 may also comprise an output (not shown) for outputting the depth map, for example to a gaming or display device. Alternatively, the computing system 300 may be located remotely from the depth camera 104 (e.g., as part of a gaming console), and the computing system 300 may receive parameters from the depth camera 104 in order to generate a depth map.

As described above, accurate modeling of a virtual skeleton by the depth camera 104 can be confounded by excess ambient light received at the depth camera 104. To reduce the ambient light received at the depth camera 104, capture device 102 includes components to restrict the wavelength of light received at the depth camera 104, including a wavelength stabilized laser diode 106 and a temperature controller 108. An optical bandpass filter 110 is also included to pass the wavelength of the laser diode to the sensor and block other wavelengths of light present in the scene, such as ambient light.

To project imaging light onto a scene, the capture device 102 includes a wavelength stabilized laser diode 106 for projecting infrared light. The wavelength stabilized laser diode 106 may be coupled to the depth camera 104 in one embodiment, while in other embodiments it may be separate. Standard, non-stabilized laser diodes, referred to as Fabre-Perot laser diodes, may undergo temperature-dependent wavelength changes that result in light being emitted in a broad range of wavelengths as laser temperature varies. Thus it is required to include expensive active cooling to limit the range of wavelengths emitted by the laser diode. In contrast, the wavelength stabilized laser diode 106 may be configured to emit light in a relatively narrow wavelength range that remains stable as a temperature of the laser diode changes. In some embodiments, the wavelength stabilized laser diode 106 may be tuned to emit light in a range of 824 to 832 nm, although other ranges are within the scope of this disclosure.

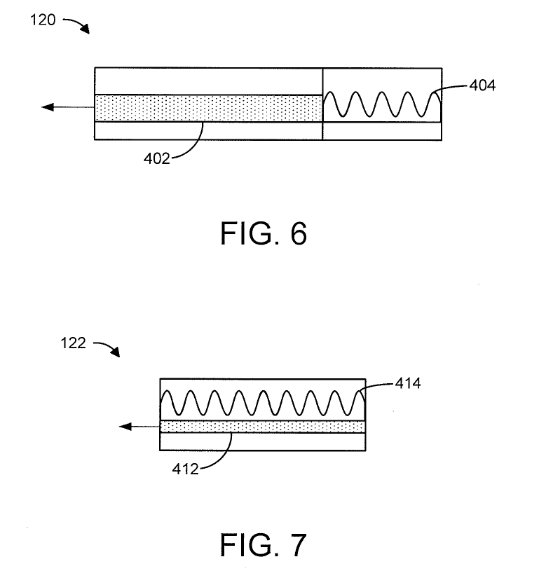

Stabilization of the wavelength stabilized laser diode 106 may be achieved by a frequency selective element that resonates light in a narrow window. For example, the frequency selective element may stabilize the laser diode such that the light emitted by the laser changes by less than 0.1 nm for each 1° C. change in laser diode temperature. In one embodiment, the wavelength stabilized laser diode 106 may include a distributed bragg reflector laser 120, discussed in more detail with reference to FIG. 6 below. In some embodiments, the wavelength stabilized laser diode 106 may include a distributed feedback laser 122, discussed in more detail with reference to FIG. 7. Any frequency selective element that stabilizes the wavelength of light emitted from the wavelength stabilized laser diode 106 is within the scope of this disclosure.

FIGS. 6 and 7 schematically show two example frequency selective elements according to the present disclosure. FIG. 6 schematically shows a distributed bragg reflector laser 120 including an active medium 402 with at least one corrugated grating 404 coupled to at least one end of the active medium 402. The corrugated grating 404 provides optical feedback to the laser to restrict light emission to a relatively narrow wavelength window. As light propagates from and through the active medium 402, it is reflected off the corrugated grating 404. The frequency and/or amplitude of the corrugated grating 404 determines the wavelength of reflected light.

The corrugated grating 404 can be made from but is not limited to materials typically found in the construction of the laser diode. While one corrugated grating is shown, distributed bragg reflector laser 120 may include two corrugated gratings with the active medium 402 positioned between the gratings. The active medium 402 may include any suitable semiconducting substance such as gallium arsenide, indium gallium arsenide, or gallium nitride.

FIG. 7 schematically shows a distributed feedback laser 122 also including a corrugated grating 414 coupled to an active medium 412. In contrast to the distributed bragg reflector laser 120, distributed feedback laser 122 has the active medium 412 and the corrugated grating 414 integrated into one unit.

Returning to FIG. 3, to further stabilize the wavelength of light emitted by the wavelength stabilized laser diode 106, the capture device 102 may include a temperature controller 108 coupled to the wavelength stabilized laser diode 106. The temperature controller 108 actively cools the wavelength stabilized laser diode 106 and includes a thermoelectric cooler 112, or Peltier device, coupled to the wavelength stabilized laser diode 106 to pump heat from the wavelength stabilized laser diode 106 to a heat sink 114. When current runs through the thermoelectric cooler 112, heat is transferred from the laser diode 106 to the heat sink 114 and dissipated into air via a fan 118. A thermocouple 116, which may be coupled to the thermoelectric cooler 112 and the heat sink 114, can determine a temperature of the thermoelectric cooler 112 and/or heat sink 114, and may control activation of the fan 118 and/or thermoelectric cooler 112 to maintain the wavelength stabilized laser diode 106 within a predetermined temperature range.

The wavelength stabilized laser diode 106 may be thermally controlled by the temperature controller 108 within a broad range of ambient temperatures. For example, the capture device 102 may be operated in an environment having a temperature range of 5 to 40° C., and therefore the wavelength stabilized laser diode 106 may be configured to remain stable at any temperature in that range. Further, the wavelength stabilized laser diode 106 may be controlled by the temperature controller 108 to remain within 1° C. of a predetermined set temperature. Thus, even as an ambient environment around the wavelength stabilized laser diode 106 increases in temperature, the temperature controller 108 can maintain the wavelength stabilized laser diode 106 at a set temperature to provide further stabilization of the emitted light. For example, the wavelength stabilized laser diode 106 may be actively cooled to remain in a range of 40 to 45° C., or another suitable temperature range.

The combination of the frequency selective element in the wavelength stabilized laser diode 106 and the temperature controller 108 coupled to the wavelength stabilized laser diode 106 act to narrowly restrict the wavelength of emitted imaging light, and thus narrowly restrict the wavelength of the reflected imaging light. However, before being received at the depth camera 104, the reflected imaging light may first pass through an optical bandpass filter 110 coupled to the depth camera 104 and configured to block substantially all light other than the imaging light.

The optical bandpass filter 110 may allow transmission of a narrow range of light in order to reduce the transmission of ambient light. To accomplish this, the optical bandpass filter 110 may be comprised of a material, such as colored glass, that transmits light in a wavelength range that matches the wavelength of the imaging light. As one example, the optical bandpass filter 110 may have a transmission range of less than 15 nm full width at half maximum (FWHM). That is, the optical bandpass filter 110 may allow transmission of light of a predetermined wavelength, as well as a 15 nm “window” on either side of that wavelength.

As the transmission range of the optical bandpass filter 110 narrows, so too does the wavelength range of light received at the depth camera 104. As such, in some embodiments, the capture device 102 may be configured with an optical bandpass filter 110 that has a transmission range as wide as the variation of light emitted from the wavelength stabilized laser diode 106. For example, the optical bandpass filter 110 may have a transmission range no greater than 5 nm FWHM, or it may have a transmission range no greater than 2 nm FWHM.

Together, the wavelength stabilized laser diode 106, temperature controller 108, and optical bandpass filter 110 enable the capture device 102 to block a large amount of ambient light from reaching the depth camera 104. In particular, the active cooling of temperature controller 108 maintains the wavelength of light emitted from wavelength stabilized laser diode 106 to a narrower range than would be possible without active cooling. Consequently, the bandpass filter 110 can be set to pass only a very narrow range of wavelengths corresponding to the tightly controlled laser. Therefore, a very large portion of ambient light is blocked from depth camera 104, thus allowing the depth camera to more accurately model an observed scene.

Turning to FIG. 4, an embodiment of a passively cooled capture device 202 configured to block ambient light is shown. Similar to the capture device 102, the capture device 202 includes a depth camera 204 configured to use imaging light to generate a depth map and a wavelength stabilized laser diode 206 to project the imaging light. In one embodiment, the wavelength stabilized laser diode 206 may include a distributed bragg reflector laser 220, while in some embodiments wavelength stabilized laser diode 206 may include a distributed feedback laser 222.

In contrast to the capture device 102 described with respect to FIG. 3, the capture device 202 includes a passive cooling system coupled to the wavelength stabilized laser diode 206. The passive cooler comprises a heat sink 208 thermally coupled to the wavelength stabilized laser diode 206 without an intermediate Peltier device. In this way, heat generated by the wavelength stabilized laser diode 206 may be passed to the heat sink 208. However, this passive cooling system may allow the wavelength stabilized laser diode 206 to operate over a wider temperature range than the active temperature controller 108 and wavelength stabilized laser diode 106, resulting in a wider range of light emitted from the wavelength stabilized laser diode 206. Nonetheless, the passive cooling system may be less expensive, and allow the wavelength stabilized laser to project light with an acceptable range of wavelengths.

In order to expedite the wavelength stabilized laser diode 206 start up in cool ambient temperatures, a heater 210 may be thermally coupled to the wavelength stabilized laser diode 206 without an intermediate Peltier device. The heater 210 may be thermally coupled to the laser diode 206 instead of or in addition to the heat sink 208. The heater 210 may be activated in response to a thermocouple 212, coupled to the wavelength stabilized laser diode 206, indicating a temperature of the wavelength stabilized laser diode 206 is below a threshold.

The capture device 202 includes an optical bandpass filter 214 coupled to the depth camera 204. The optical bandpass filter 214 may have a wider transmission range than the optical bandpass filter 110 of the embodiment described with reference to FIG. 3 to compensate for the wider range of light emitted by the wavelength stabilized laser diode 206. The optical bandpass filter 214 may have a transmission range greater than 5 nm FWHM and less than 20 nm FWHM. In some embodiments, the optical bandpass filter 214 may have a transmission range of less than or equal to 10 nm at 90% maximum transmission. In general, the optical bandpass filter 214 may be configured to allow the imaging light emitted from the wavelength stabilized laser diode 206 to pass to the depth camera 204 while blocking most ambient light present in the imaged scene.

The above described embodiments may each have specific advantages. For example, the capture device 102 described in reference to FIG. 3, where the laser diode is actively temperature controlled, may provide very precise control over the range of the wavelength of light emitted from the wavelength stabilized laser diode 106. In turn, the bandpass filter 110 may have a narrow transmission range, and therefore a substantial amount of ambient light may be prevented from reaching the depth camera 104. On the other hand, the passively cooled system may be less costly than the actively controlled system, and therefore of more practical use for certain applications.

In some embodiments, the above described methods and processes may be tied to a computing system including one or more computers. In particular, the methods and processes described herein may be implemented as a computer application, computer service, computer API, computer library, and/or other computer program product.

FIG. 5 schematically shows a nonlimiting computing system 300 that may perform one or more of the above described methods and processes. Computing system 300 is shown in simplified form. It is to be understood that virtually any computer architecture may be used without departing from the scope of this disclosure. In different embodiments, computing system 300 may take the form of a mainframe computer, server computer, desktop computer, laptop computer, tablet computer, home entertainment computer, network computing device, mobile computing device, mobile communication device, gaming device, etc.

Computing system 300 includes a logic subsystem 302 and a data-holding subsystem 304. Computing system 300 may also optionally include user input devices such as keyboards, mice, game controllers, cameras, microphones, and/or touch screens, for example.

Logic subsystem 302 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 304 may include one or more physical, non-transitory, devices configured to hold data and/or instructions executable by the logic subsystem to implement the herein described methods and processes. When such methods and processes are implemented, the state of data-holding subsystem 304 may be transformed (e.g., to hold different data).

Data-holding subsystem 304 may include removable media and/or built-in devices. Data-holding subsystem 304 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 304 may include devices with one or more of the following characteristics: volatile, nonvolatile, dynamic, static, read/write, read-only, random access, sequential access, location addressable, file addressable, and content addressable. In some embodiments, logic subsystem 302 and data-holding subsystem 304 may be integrated into one or more common devices, such as an application specific integrated circuit or a system on a chip.

FIG. 5 also shows an aspect of the data-holding subsystem in the form of removable computer-readable storage media 306, which may be used to store and/or transfer data and/or instructions executable to implement the herein described methods and processes. Removable computer-readable storage media 306 may take the form of CDs, DVDs, HD-DVDs, Blu-Ray Discs, EEPROMs, and/or floppy disks, among others.

It is to be appreciated that data-holding subsystem 304 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module,” “program,” and “engine” may be used to describe an aspect of computing system 300 that is implemented to perform one or more particular functions. In some cases, such a module, program, or engine may be instantiated via logic subsystem 302 executing instructions held by data-holding subsystem 304. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from a client.

As introduced above, the present disclosure may be used with structured light or time-of-flight depth cameras. In time-of-flight analysis, the capture device may emit infrared light to the target and may then use sensors to detect the backscattered light from the surface of the target. In some cases, pulsed infrared light may be used, wherein the time between an outgoing light pulse and a corresponding incoming light pulse may be measured and used to determine a physical distance from the capture device to a particular location on the target. In some cases, the phase of the outgoing light wave may be compared to the phase of the incoming light wave to determine a phase shift, and the phase shift may be used to determine a physical distance from the capture device to a particular location on the target.

In another example, time-of-flight analysis may be used to indirectly determine a physical distance from the capture device to a particular location on the target by analyzing the intensity of the reflected beam of light over time, via a technique such as shuttered light pulse imaging.

In structured light analysis, patterned light (i.e., light displayed as a known pattern such as a grid pattern, a stripe pattern, a constellation of dots, etc.) may be projected onto the target. On the surface of the target, the pattern may become deformed, and this deformation of the pattern may be studied to determine a physical distance from the capture device to a particular location on the target.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A 3-D imaging system comprising:
a wavelength stabilized laser diode to project imaging light onto a scene;
a temperature controller configured to stabilize a temperature of the wavelength stabilized laser diode throughout a range of ambient temperatures;
an optical bandpass filter having a transmission range less than 5 nm full width at half maximum; and
a camera to receive imaging light reflected from the scene and through the optical bandpass filter.

2. The 3-D imaging system of claim 1, wherein the temperature controller includes a thermoelectric cooling device coupled to the wavelength stabilized laser diode.

3. The 3-D imaging system of claim 2, wherein the thermoelectric cooling device includes a Peltier device.

4. The 3-D imaging system of claim 2, wherein the thermoelectric cooling device is configured to maintain a temperature of the wavelength stabilized laser diode to within 1° C. of a predetermined set temperature while the wavelength stabilized laser diode is operated within an environment having an ambient temperature between 5° C. and 40° C.

5. The 3-D imaging system of claim 1, wherein the wavelength stabilized laser diode comprises a distributed bragg reflector.

6. The 3-D imaging system of claim 1, wherein the wavelength stabilized laser diode comprises a distributed feedback laser.

7. The 3-D imaging system of claim 1, wherein the camera is configured to analyze the received imaging light using time of flight analysis.

8. The 3-D imaging system of claim 1, wherein the camera is configured to analyze the received imaging light using structured light analysis.

9. The 3-D imaging system of claim 1, wherein the optical bandpass filter has a transmission range no greater than 2 nm full width at half maximum.

10. The 3-D imaging system of claim 1, wherein the laser diode is tuned to emit light having a wavelength in a range of 824 nm to 832 nm.

11. The 3-D imaging system of claim 1, wherein the laser diode is tuned to emit light in a wavelength range that matches a range transmitted by the optical bandpass filter when operated within an environment having an ambient temperature between of 5° C. and 40° C.

12. A 3-D imaging system comprising:
a wavelength stabilized laser diode to project imaging light onto a scene with a wavelength in a range of 824 nm to 832 nm;
a cooling device coupled to the wavelength stabilized laser diode and configured to maintain the wavelength stabilized laser diode within a temperature range of 40° to 45° C. when operated within an environment having an ambient temperature between 5° C. and 40° C.;
an optical bandpass filter having a transmission range no greater than 5 nm full width at half maximum; and
a camera to receive imaging light reflected from the scene and through the optical bandpass filter.

13. The imaging system of claim 12, wherein the cooling device comprises a thermoelectric cooler, a heat sink, a thermocouple, and a fan.

14. The imaging system of claim 12, wherein the wavelength stabilized laser diode comprises a distributed bragg reflector.

15. The imaging system of claim 12, wherein the wavelength stabilized laser diode comprises a distributed feedback laser.

16. The imaging system of claim 12, wherein the camera is configured to analyze the received imaging light using time of flight analysis.

17. The imaging system of claim 12, wherein the camera is configured to analyze the received imaging light using structured light analysis.

18. A 3-D imaging system comprising:
a wavelength stabilized laser diode to project imaging light onto a scene;
a temperature controller configured to stabilize a temperature of the wavelength stabilized laser diode throughout a range of ambient temperatures;
an optical bandpass filter having a transmission range less than 15 nm full width at half maximum;
a camera to receive imaging light reflected from the scene and through the optical bandpass filter;
a data-holding subsystem holding instructions executable by a logic subsystem to analyze the imaging light received at the camera to generate a depth map; and
an output for outputting the depth map.

19. The 3-D imaging system of claim 18, wherein the temperature controller includes a thermoelectric cooling device coupled to the wavelength stabilized laser diode.

20. The 3-D imaging system of claim 18, wherein the range of ambient temperatures comprises 5° to 40° C.
